(19) United States
(12) Patent Application Publication
(10) Pub. No.: US 2016/0288143 A1
(43) Pub. Date: Oct. 6, 2016

(54) SPRAYS

(71) Applicant: CAMBRIDGE CONSULTANTS LIMITED, Cambridge (GB)

(72) Inventors: Julia E. GREENWOOD, Cambridge (GB); Simon BURGE, Haverhill (GB); Simon J. SMITH, Hertford (GB)

(73) Assignee: CAMBRIDGE CONSULTANTS LIMITED, Cambridge (GB)

(21) Appl. No.: 15/028,270

(22) PCT Filed: Oct. 3, 2014
(86) PCT No.: PCT/GB14/53001

§ 371 Date: Apr. 8, 2016

(30) Foreign Application Priority Data
Oct. 8, 2013 (GB) 1317796.9

(51) Int. Cl. B05B 1/34; B05B 7/24

(52) U.S. Cl. CPC B05B 1/3426; B05B 7/2445; B05B 7/2472

(57) ABSTRACT

A spray apparatus includes an outlet connected to a cyclone chamber with at least one gas inlet to the chamber connected to a pressurized source of gas, and at least one liquid inlet to the chamber for connection to a liquid source. The cyclone chamber has a cross section that decreases in a direction away from the outlet and a closed base such that in use at least one of the liquid and gas entering the chamber forms a reverse flow cyclone, in which the liquid or gas travels in a first direction away from the inlet to the closed base and thereafter reverses direction and travels towards the outlet.

This invention relates to methods and apparatus for spraying liquids, in particular to the atomization of a liquid to form a spray.

Traditionally sprays are formed by forcing liquid through a narrow nozzle which gives rise to high shear forces that breaks the liquid into small droplets. This can be driven by pressurising the liquid (e.g. in spray canisters) or by using pressure differences generated by gas flow (e.g. in airbrushes). However in both cases a wide range of droplets sizes are produced, giving an inconsistent spray quality.

Moreover in arrangements driven by pressurising the liquid, it is typically accepted that pressures of the order of 4 bar or more are necessary to produce acceptable results. This can cause difficulties and carries with it a certain level of costs. It may therefore be beneficial to have a lower operating pressure.

When viewed from a first aspect, this invention provides a spray apparatus comprising an outlet connected to a cyclone chamber, at least one gas inlet to the chamber connected to a pressurised source of gas, and at least one liquid inlet to the chamber for connection to a liquid source, wherein the cyclone chamber has a cross section which decreases in a direction away from the outlet and a closed base such that in use at least one of the liquid and gas entering the chamber forms a reverse flow cyclone, in which the liquid or gas travels in a first direction away from the inlet to the closed base and thereafter reverses direction and travels towards the outlet.

The invention extends to a method of producing a liquid spray from an outlet connected to a cyclone chamber, wherein the cyclone chamber comprises a cross section which decreases in a direction away from the outlet and a closed base, the method comprising passing a pressurised gas into said cyclone chamber via at least one gas inlet, passing a pressurised liquid into said cyclone chamber via at least one liquid inlet and thereby forming a reverse flow cyclone from at least one of the liquid and gas in which the liquid or gas travels in a first direction away from the inlet to the closed base and thereafter reverses direction and travels towards the outlet so as to form droplets of the liquid in the cyclone chamber, said droplets being sprayed out from the outlet.

Thus it can be seen that in accordance with the invention a reverse flow cyclone is used to produce a spray. The Applicant has found that at least in preferred embodiments this can allow a higher quality spray to be achieved with a smaller distribution of droplet sizes for the same or lower pressure as can be achieved for a conventional spray. Without being bound by any particular theory and emphasising that this is not intended to be limiting it is believed that the reverse flow cyclone causes shear in the liquid, breaking up the laminar flow into droplets. By introducing a gas into the chamber, i.e. a fluid of low viscosity, there is increased shear on the liquid, causing increased break up of the flow. This is because there are shear forces between the liquid and gas, as well as due to the counter-rotating parts of the cyclone. By introducing the shear through the reverse cyclone, it is not necessary to atomise the liquid at the exit orifice, as in traditional spray equipment.

The apparatus may comprise a liquid source. The liquid source may be detachable or interchangeable. It may form an integral part of the apparatus. There is a wide variety of liquids that could be used depending on the particular application. A few non-limiting examples include water, paint, cosmetics, pharmaceuticals, fuel, agricultural chemicals, household chemicals, perfume, deodorant etc.

In a set of embodiments, the apparatus comprises a plurality of liquid inlets. These inlets may be connected to the same liquid source or to a plurality of liquid sources. In the latter case they can therefore be used to mix a plurality of liquids at the point of spraying. This is advantageous as it has been found to give very efficient mixing and avoids the need to store the mixed liquid which may not be stable. The apparatus may also have a plurality of gas inlets. These could be connected to the same gas source or a plurality of different gas sources.

The liquid source may itself be pressurised, but in a set of embodiments the liquid is pressurised by the pressurised source of gas. In either case pressure may be provided by any suitable method, for example by a pump, electric fan, or expansion of volatile organic compounds (VOCs).

Where VOCs are used as the pressure source, the liquid and VOCs may be stored mixed together, as in traditional spray equipment. However, in a set of embodiments, the liquid and volatile organic compounds are stored separately. This may be through the use of separate compartments within a canister, but in a set of embodiments the liquid is stored in a bag within the volatile organic compounds.

In fact where VOCs are used as the pressure source, the Applicant has found that it may not be necessary for the liquid and gas to be introduced into the cyclone chamber separately. Thus when viewed from a second aspect, the invention provides a spray apparatus comprising an outlet connected to a cyclone chamber, at least one inlet to the chamber connected to a source of liquid pressurised using volatile organic compounds, wherein the cyclone chamber has a cross section which decreases in a direction away from the outlet and a closed base such that in use the liquid entering the chamber forms a reverse flow cyclone, in which the liquid travels in a first direction away from the inlet to the closed base and thereafter reverses direction and travels towards the outlet.

In a set of embodiments, the cyclone chamber may be ‘pre-dosed’ with a substance before it is used for spraying. This is when a fixed amount of a substance is entered into the chamber before use. When the spraying device is then used, the reverse cyclone formed by the liquid and gas will cause the substance to be mixed in with the liquid droplets to form the spray.

In accordance with either aspect of the invention the gas and/or liquid may be pressurised to between 50 kPa and 2000 kPa, e.g. between 100 kPa and 500 kPa. The Applicant has found that a consistent spray quality can be achieved at these pressures, which it will be appreciated are lower than required in conventional spraying apparatus.

The inlets may comprise feed-in tubes, which connect a fluid source to the cyclone chamber. These feed-in tubes may be cylindrical but in a set of embodiments one or more of the inlet tubes is tapered, reducing in cross-section towards the chamber. This has been found to be beneficial for some fluids. Taking the central axis of the cyclone chamber extending from the base and around which the reverse cyclone circulates in use, the feed-in tubes may approach the chamber at any of a range of angles to the axis and the angle may be different for each but in a set of embodiments the angle between the feed-in tubes and the axis of the chamber is substantially 90°.

In a set of embodiments, the feed-in tubes are substantially tangential to the cyclone chamber, preferably in the same rotational sense. This causes the fluids to enter the chamber in the same direction, enhancing the reverse flow cyclone formed.

The inlets may be arranged at any angular spacing around the chamber, but in a set of embodiments they are arranged equiangularly. The feed-in tubes may have different lengths, but in a set of embodiments they are all of equal length. This allows for even mixing of the fluids, as they all undergo the same conditions as they approach the cyclone chamber.

The inlets could be arranged in a number of different planes, but in a set of embodiments they are all in substantially the same plane. This ensures that the fluids all form cyclones of substantially the same size, causing even mixing and similar sized droplets.

The outlet could simply comprise an aperture in the top of the cyclone chamber (the top being defined as the wall furthest from the base where the cyclone reverses direction) with no significant axial extent. However in a set of embodiments the outlet is elongate (i.e. has a longitudinal extent greater than its maximum diameter). In a set of embodiments, the outlet is tapered so as to reduce in cross section away from the cyclone chamber. This allows for a smooth transition from the interior of the cyclone chamber to the distal mouth of the outlet which has been found to be beneficial in some circumstances.

In a set of embodiments the outlet extends into the cyclone chamber, proud of the top of the chamber. In a set of such embodiments the outlet extends further along the axis of the chamber towards the base than the location of at least one, preferably all, of the inlets. This can help to prevent fluid from the inlets ‘short-circuiting’ the chamber by travelling directly out of the outlet without forming a reverse cyclone. This can also be achieved with a wall, baffle or other formation which is separate from the outlet. Thus in general in a set of embodiments the cyclone chamber is arranged such that fluid entering one or more inlets is required to turn by more than 90° to the axis to exit from the outlet.

Additionally or alternatively, the outlet may extend away from the cyclone chamber, into the spray path. Features of the outlet can be changed in order to modify the shape of the spray, for example the outlet cross-sectional shape or length.

The cyclone chamber may take any shape with a decreasing cross section, but in a set of embodiments it comprises a frusto-conical portion.

The cyclone chamber may have an aspect ratio, defined as the ratio between the length of the chamber (from the base to the beginning of the outlet or the widest point of the outlet) divided by the diameter of the chamber at its widest point. In a set of embodiments the aspect ratio is between 1 and 5, e.g. between 1 and 2, e.g. between 1 and 1.5

The absolute dimensions of the cyclone chamber will depend upon the application. However one of the advantages which the invention may provide is that a spray can be formed effectively in a relatively small chamber. In a set of exemplary embodiments the cyclone chamber is less than 3 cm in diameter (at its widest point), e.g. less than 1 cm in diameter, e.g. less than 0.6 cm, e.g. less than 0.4 cm.

The cyclone chamber preferably has a length (as defined hereinabove) less than 5 cm, e.g. less than 3 cm, e.g. less than 1 cm.

The minimum diameter of the outlet (which may be at the furthest point from the interior of the chamber) may be selected according to the flow rate desired in the spray, but is preferably between 0.1 mm and 1 mm, e.g. between 0.2 mm and 0.5 mm. In a set of embodiments, this value is between 2 and 20% of the chamber diameter (at its widest point), further between 5 and 15%.

The feed-in tubes can be varied in size according to the application, with both the diameter and length affecting the quality of the spray produced. In a set of embodiments, the feed in tubes are between 0.1 mm and 1 cm in diameter. In a set of embodiments, the feed in tubes have a diameter of between 2 and 20% of the chamber diameter (at its widest point), further between 5 and 15%. In a set of embodiments the feed-in tubes are between 0.5 cm and 5 cm in length.

The ratio between the minimum diameter of the outlet and the diameter of the feed in tubes may vary according to the application and the desired droplet size, but in a set of embodiments the optimal ratio is between 0.5 and 2, e.g. approximately 1.

The ratio of the liquid and gas pressures affects the droplet size produced by the cyclone chamber. In a set of embodiments, the ratio of gas to liquid pressure is between 0.5 and 1.5. This can give a range of droplet sizes between 100 μm and 33 μm. In an alternative set of embodiments, the ratio of gas to liquid pressure is greater than or equal to 1, e.g. greater than 2 or greater than 4. This is because having a greater gas pressure may create smaller liquid droplets, creating a finer spray.

The method of the invention may comprise commencing passing the liquid and the into the cyclone chamber at the same time, but in a set of embodiments the gas is passed into the cyclone chamber before the liquid. This may allow the gas to set up a reverse flow cyclone before the liquid is introduced, which may increase the quality of the spray. Alternatively or additionally, the method may comprise ceasing passing the gas into the cyclone chamber after ceasing passing the liquid into the chamber. This may allow the cyclone chamber to be cleaned, removing fluid which remains in the chamber after passing liquid into the chamber has ceased. The apparatus of the invention may be arranged to execute such operations in use. Alternatively, the liquid and gas may only be turned on as a user demands, allowing the order in which the liquid and gas enter the chamber and the length of time for which they are active to be tailored by the user, rather than operating in a predetermined manner.

When viewed from a third aspect, the invention provides a device for producing a spray comprising an outlet, a cyclone chamber connected to the outlet and a plurality of inlets adapted to be connected to fluid sources, wherein the cyclone chamber comprises a cross section which decreases in a direction away from the outlet and a closed base such that in use at least one fluid entering the chamber forms a reverse flow cyclone in which the fluid travels in a first direction away from the inlet to the base of the chamber and thereafter reverses direction and travels towards the outlet, thereby forming a spray which is emitted from the outlet.

The features of sets of embodiments of the first and second aspects of the invention may also be applied to the third aspect of the invention.

A number of embodiments of the invention will now be described, by way of example only, with reference to the accompanying drawings in which:

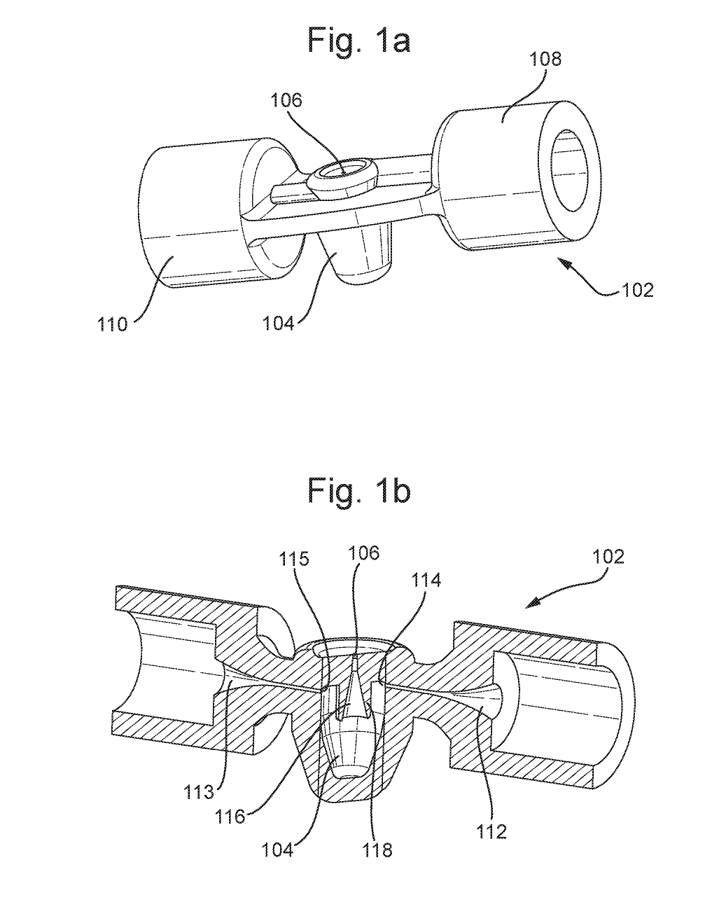

FIGS. 1a and 1b illustrate an embodiment of the invention in which there are two inlets to the cyclone chamber;

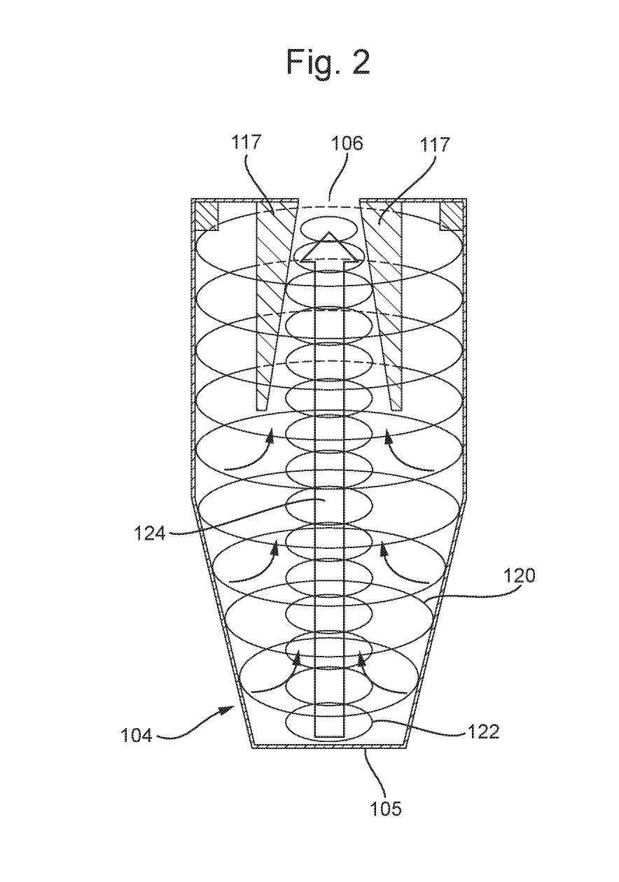

FIG. 2 illustrates the formation of a reverse flow cyclone in a cyclone chamber;

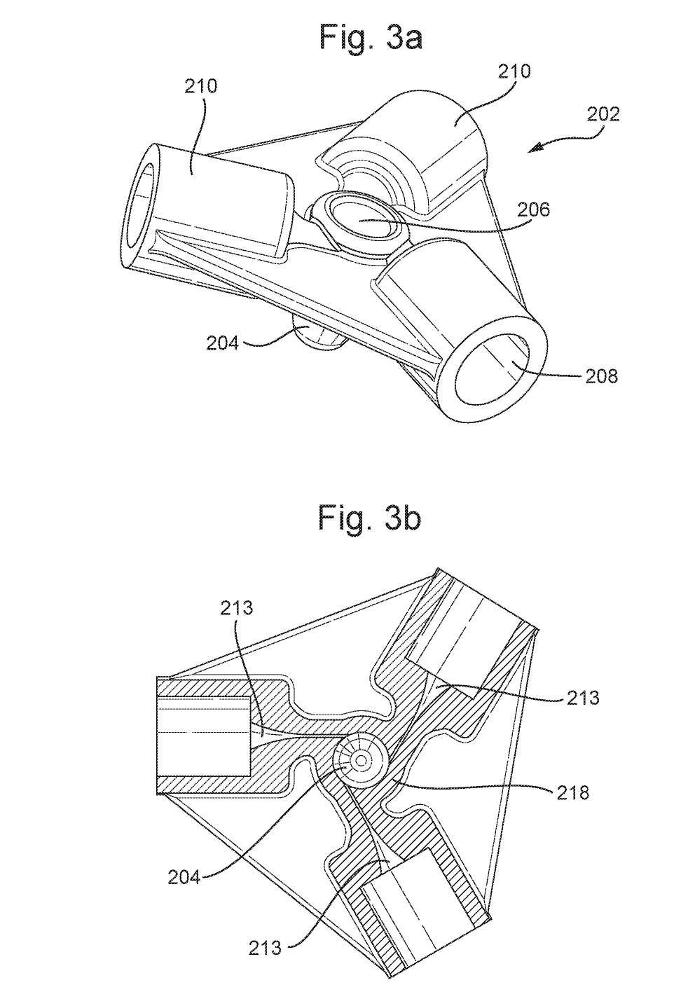

FIGS. 3a and 3b illustrate an embodiment of the invention in which there are three inlets to the cyclone chamber;

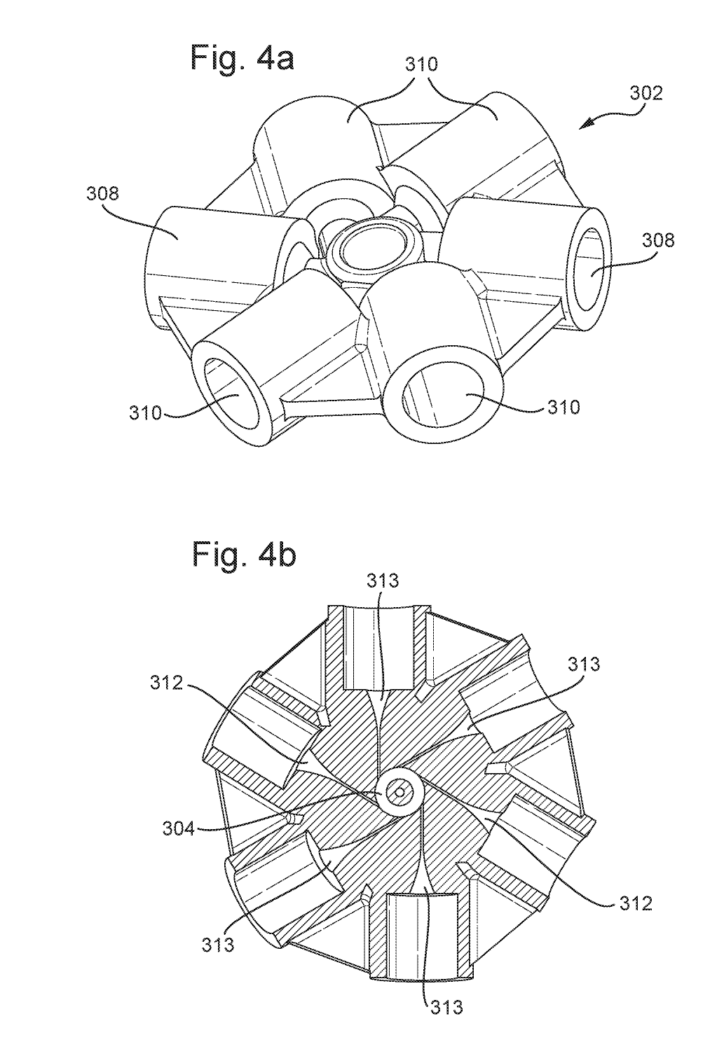

FIGS. 4a and 4b illustrate an embodiment of the invention in which there are six inlets to the cyclone chamber;

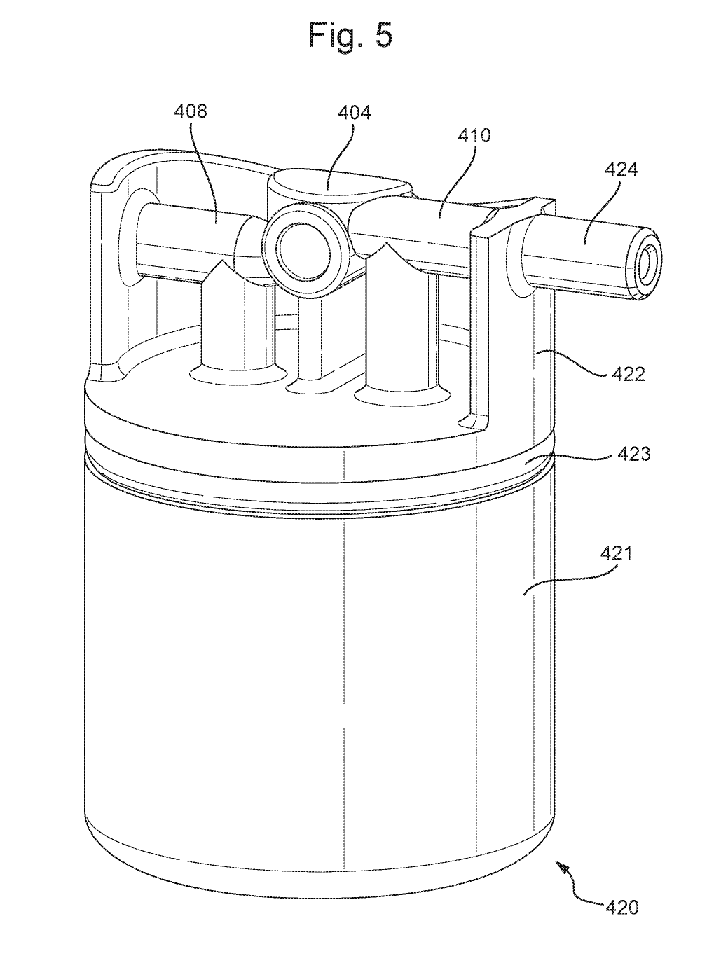

FIG. 5 illustrates a spraying device comprising a spray nozzle in accordance with the invention;

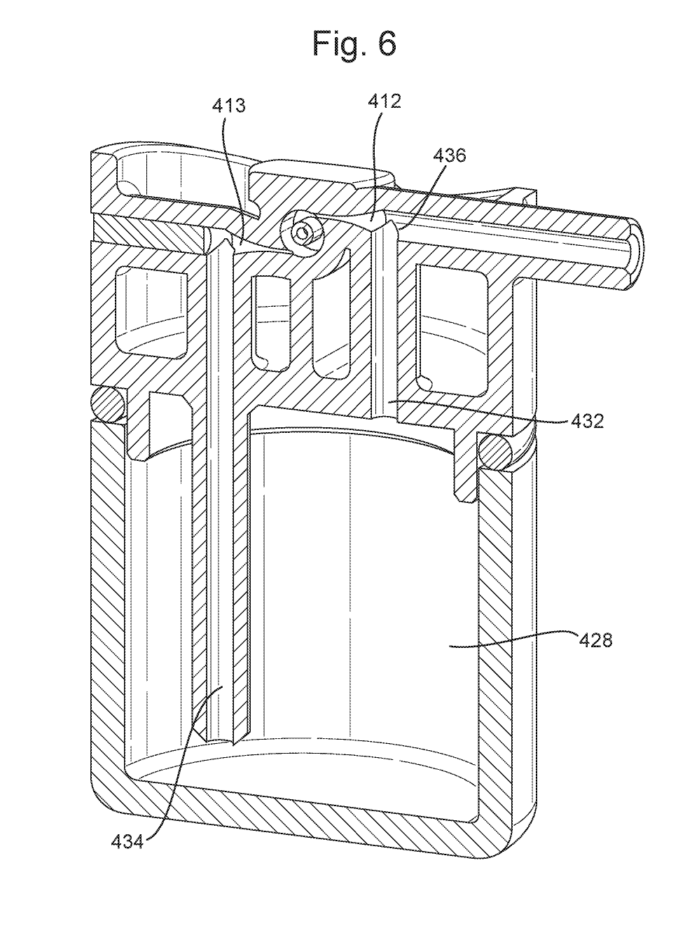

FIG. 6 is a cross-sectional views of the device of FIG. 5;

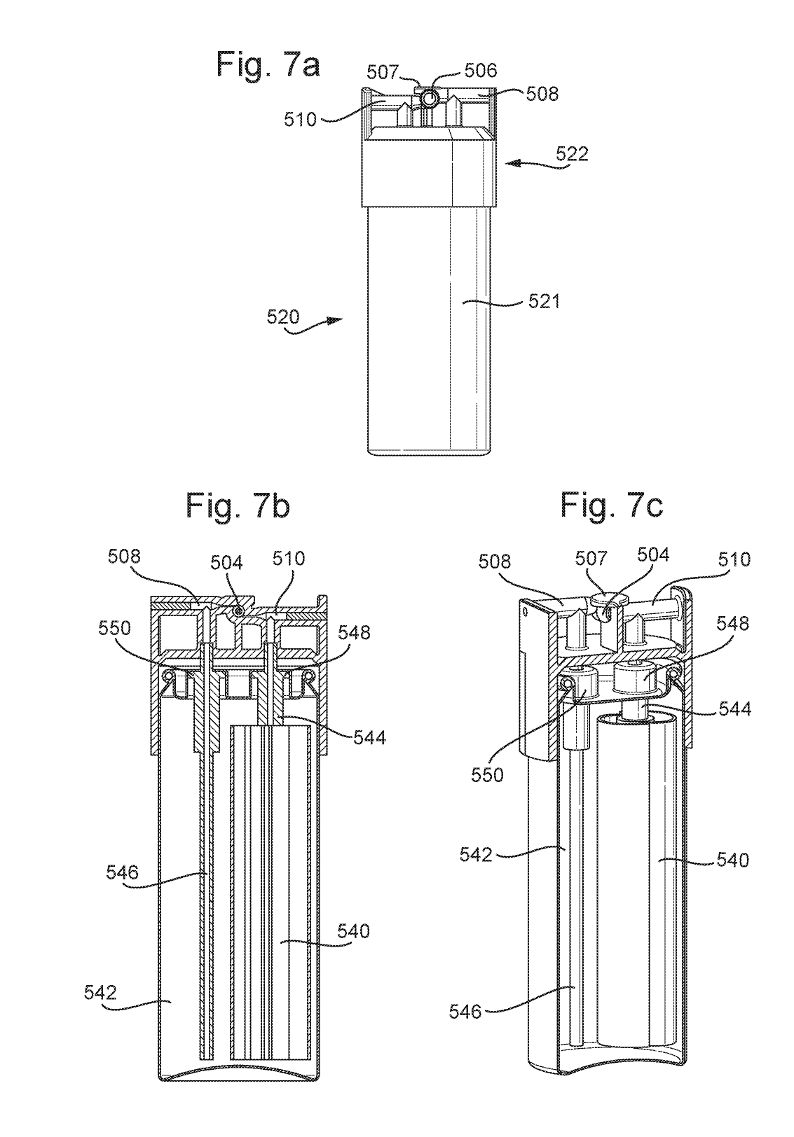

FIGS. 7a to 7c illustrate an alternative spraying device comprising a nozzle in accordance with the invention;

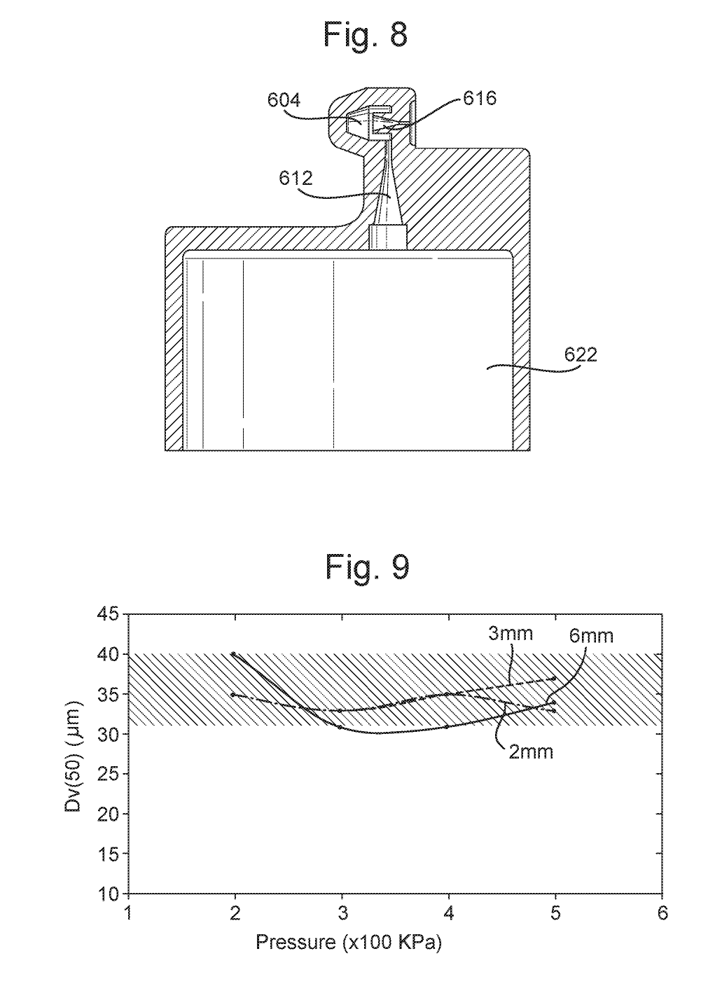

FIG. 8 illustrates an alternative aspect of the invention with only one inlet; and

FIG. 9 is a graph showing the variation in droplet size with pressure for a number of chamber diameters.

FIGS. 1a and 1b show a spray nozzle 102, which uses a cyclone chamber 104 to produce a plurality of liquid droplets using a reverse flow cyclone which can then be sprayed through the exit aperture 106. This embodiment comprises two ports for connecting to fluid sources 108, 110, which in this example are for a gas and a liquid respectively. These ports 108, 110 lead to fluid inlet arrangements 112, 113. The fluid inlet arrangements 112, 113 comprise feed-in tubes 114, 115 which taper from the ports 108, 110 to the cyclone chamber 104. This tapering allows fluid to enter the cyclone chamber 104 with minimal turbulence, and increases the velocity of the fluid. The feed-in tubes 112, 113 are tangential to the cyclone chamber 104, as can be seen from FIG. 1b. This is beneficial to the formation of a reverse flow cyclone, helping to create a better quality spray. The cyclone chamber 104 also contains a tapered outlet 116, which allows for liquid droplets in the inner cyclone to be selected and sprayed out of the exit aperture 106. The tapered outlet is surrounded by a wall 118, which not only causes the tapering, but also prevents liquid and gas from travelling directly from the inlet arrangements 112,113 to the outlet 116 without forming a reverse cyclone.

Operation of the device will now be described with additional reference to FIG. 2. In use, the liquid and gas enter the cyclone chamber 104 tangentially from the inlets 112, and set up reverse cyclonic flow. The gas and liquid follow the wall of the chamber, forming a spiralling path. This path advances along the length of the chamber, with the diameter of the path followed by the liquid and gas decreasing as the chamber 104 tapers. When the liquid and gas reach the base of the chamber 105, the flow is reversed, setting up a smaller vortex 122 which travels through the centre of the chamber 104. This combination of a large outer vortex 120 travelling in one direction and smaller vortex 122 travelling within the outer vortex 120 in the opposite direction is known as a reverse flow cyclone. There is substantial variation in tangential velocity across the cyclone chamber 104, which creates a steep velocity gradient. This causes efficient atomisation, creating droplets with a small variation in size. The shear forces generated act on the liquid both as it travels down towards the base of the chamber 105, and as it travels back towards the tapered outlet 116. This tapered outlet 116 is formed from a wall 117 which surrounds the exit aperture 106. This wall 117 extends from the exit aperture 106 past the liquid and gas inlets 112, 113. This prevents the fluids travelling directly from the inlets 112, 113 to the exit aperture 106, and instead forces them to travel towards the base of the chamber 105, causing them to form a reverse flow cyclone as explained above. As this is a relatively long path, the liquid and gas have an increased residence time in the chamber, enhancing mixing and increasing the quality of the spray produced. By including both gas and liquid in the cyclone chamber 104, the shear forces acting on the liquid are increased, as due to the different molecular weights, there are also shear forces between the gas and liquid, as well as between the two vortices 120, 122.

The tapered outlet 116 is arranged such that droplets of a certain size pass through it, as shown by arrow 124, and are able to be sprayed out of the exit aperture 106. This is due to the combination of droplet size and pressure of the liquid and gas, as the radius of the inner cyclone is dependent on droplet size, allowing for a particular size to be selected by changing the maximum outlet radius. Due to the presence of the reverse cyclone, there is no need for a sharp reduction in size at the exit aperture 106, as the liquid has already formed droplets.

FIGS. 3a and 3b illustrate an alternative embodiment of a spray nozzle 202. This embodiment has three fluid ports, one for gas 208 and two for liquid 210. The three ports 208, 210 are connected to inlet arrangements 212, 213, which allow the fluid to flow into the chamber 204. By adding a third fluid inlet 214, it becomes possible to mix two different liquids as well as mixing the liquid with gas. This is due to the mixing effect of the reverse flow cyclone, and can add extra functionality to the spray, for example allowing liquids (e.g. paint) to be mixed at the point of spraying, rather than at an earlier stage. This can also lead to more thorough mixing of the liquids and gas, causing the liquid to atomise further and produce a higher quality spray. As can be seen from FIG. 3b, all three feed-in tubes 212 are of the same length and proportions. This encourages even mixing of the fluids, creating a better quality spray than in a system with unequal length feed-in tubes. This is assisted by the inlet arrangements 212, 213 being arranged equiangularly around the cyclone chamber 204.

FIGS. 4a and 4b illustrate a third possible embodiment of a spray nozzle 302 in which there are six fluid ports 308, 310. These ports may have any combination of liquid and gas, provided there is a minimum of one of each. A possible combination would be to have two gas ports 308 and four liquid ports 310. This would keep the pressure in the cyclone chamber 304 at an appropriate level, allowing the liquid to spray. In this embodiment, the two gas ports 308 are arranged diametrically opposite one another. This allows for maximum interaction between the liquid and gas, causing increased shear and atomisation. However, this arrangement is not essential, and any number of liquid and gas ports 310, 308 could be used. As with the embodiment of FIGS. 2a and 2b, by having feed-in tubes 312, 313 of the same length and arranged equiangularly about the cyclone chamber 204, even mixing will occur in the cyclone chamber 304.

FIG. 5 shows an embodiment of the spray nozzle integral to a spray device 420. This comprises a canister 421, a sealing mechanism 423 and a spray head 422 which includes a cyclone chamber 404 as described above. A tube 424 connects the device to a source of pressurised gas (not shown).

FIG. 6 shows a cross-section of the device 420, in which the internal arrangement can be seen. Liquid is stored in the body of the canister 421. The tube 424 reaches a T-junction 436, where it splits into two sections. One of these connects directly to the cyclone chamber 404 via a gas inlet arrangement 412, and the other enters the liquid chamber 428 at an outlet 432. The liquid chamber 428 also contains a pipe 434 which is connected to the liquid inlet arrangement 413. The liquid inlet arrangement 413 is arranged diametrically opposite the gas inlet arrangement 412.

In use, the source of pressurised gas can be turned on, allowing pressurised gas into the tube 424. From here, some gas enters the cyclone chamber 404 directly through the gas inlet arrangement 412, while some gas enters the liquid chamber 428 through the outlet 432 due to the presence of the T-junction 436. This removes the need for a secondary pressure source. The pressurised liquid can then be drawn from the pipe 434 and fed to the cyclone chamber 404 through the liquid inlet arrangement 413. As both pressurised liquid and gas enter the cyclone chamber 404 through their respective inlet arrangements 413, 412, a reverse flow cyclone is formed as demonstrated in FIG. 2. This atomises the liquid, producing droplets of a suitable size which can then be sprayed out of the outlet 406.

FIG. 7a illustrates an alternative spray device 520 containing a nozzle in accordance with the invention. The device 520 comprises a spray canister 521 and a spray head 522 which includes a reverse cyclone chamber 504 as described above. The chamber 504 is connected to two inlet arrangements, one for gas 508 and one for liquid 510, which is then sprayed out of the outlet 506.

FIGS. 7b and 7c show cross-sections of this embodiment, in which the internal arrangement can be seen. In this alternative embodiment, the liquid and VOCs are stored in two separate regions in the canister 521. A liquid bag 540 is immersed in the liquid VOCs 542, with a liquid pipe 544 forming a connection between the liquid bag 540 and the liquid inlet arrangement 510. A lower end of a gas pipe 546 is submerged within the VOCs 542, with the upper end being connected to the gas inlet arrangement 508. At the top of the liquid pipe 544 and gas pipe 546 are valves 548 and 550.

In use, the button 507 is pushed in order to activate the spray. When the button 507 is pushed, the valves 548 and 550 are opened, allowing liquid and VOCs to travel up their respective pipes 544, 546. The liquid travels up the pipe 544 under pressure from the VOCs 542. The VOCs are able to evaporate when the valve 550 is opened, producing a source of gas. The gases created by this expansion then travel up the gas pipe 546, before entering the cyclone chamber 504 through the gas inlet arrangement 508. As the liquid pipe 544 is connected to the liquid inlet arrangement 510, the liquid then enters the cyclone chamber 504. Once in the cyclone chamber 504, the liquid and gas form a reverse flow cyclone as discussed in relation to FIG. 2. This atomises the liquid, generating small droplets that are sprayed from the outlet 506.

FIG. 8 illustrates an alternative aspect of the invention, in which a spray nozzle is provided in which there is only one inlet 612 to the cyclone chamber 604. The liquid is mixed with VOCs in the body of the device 622, in order to pressurise it. The resulting mixture enters the cyclone chamber 604 through the inlet 612, where the VOCs can evaporate to form a gas, and the resulting liquid and gas form a reverse flow cyclone as explained in FIG. 2. This causes the liquid to break up into droplets, as in the previous embodiments, enabling it to be sprayed out of the nozzle 616. This spraying happens due to the pressure built up by the presence of VOCs.

FIG. 9 is a graph of droplet size against pressure for three different cyclone chambers in accordance with the invention. Droplet size is measured as the diameter which 50% of droplets are below. As can be seen, for cyclone chambers with a diameter of 2 mm, 3 mm or 6 mm, the droplet size is consistently between 30 and 40 μm over a range of 200 to 500 kPa. Each of the three chamber diameters has different variation in droplet size with pressure, with a 6 mm chamber having the smallest variation, being consistently between 32 and 35 μm over this pressure range. The operating pressures being discussed are lower than would be necessary for a traditional spray system, yet produce a consistent, high quality spray.

1-37. (canceled)

38. A spray apparatus comprising:
an outlet connected to a cyclone chamber;
at least one gas inlet to the chamber connected to a pressurized source of gas; and
at least one liquid inlet to the chamber for connection to a liquid source;
wherein the cyclone chamber has a cross section that decreases in a direction away from the outlet and a closed base such that in use at least one of the liquid and gas entering the chamber forms a reverse flow cyclone, and wherein the liquid or gas travels in a first direction away from the inlet to the closed base and thereafter reverses direction and travels towards the outlet.

39. An apparatus as claimed in claim 38, comprising a liquid source.

40. An apparatus as claimed claim 39, wherein the liquid source is pressurized by the pressurized source of gas.

41. An apparatus as claimed in claim 38, comprising a plurality of liquid inlets.

42. An apparatus as claimed in claim 38, wherein the liquid is stored in a bag within the gas or liquefied gas.

43. An apparatus as claimed in claim 41, wherein the liquid and gas inlets comprise feed-in tubes.

44. An apparatus as claimed in claim 43, wherein the angle between the feed-in tubes and the central axis of the cyclone chamber is substantially 90°.

45. An apparatus as claimed in claim 43, wherein the feed-in tubes are substantially tangential to the cyclone chamber.

46. An apparatus as claimed in claim 41, wherein the liquid and gas inlets are arranged equiangularly around the chamber.

47. An apparatus as claimed in claim 38, wherein the outlet is elongate.

48. An apparatus as claimed in claim 38, wherein the outlet is tapered.

49. An apparatus as claimed in claim 38, wherein the outlet extends into the cyclone chamber.

50. An apparatus as claimed in claim 49, wherein the outlet extends further along the axis of the chamber towards the base than a location of at least one of the inlets.

51. An apparatus as claimed in claim 38, wherein the cyclone chamber comprises a frusto-conical portion.

52. An apparatus as claimed in claim 38, wherein the cyclone chamber has an aspect ratio between 1 and 5, wherein the aspect ratio is defined as the ratio between a length of the chamber divided by a diameter of the chamber at its widest point.

53. An apparatus as claimed in claim 38, wherein the cyclone chamber is less than 3 cm in diameter at its widest point.

54. An apparatus as claimed in claim 38, wherein the ratio of gas to liquid pressure is greater than 0.5.

55. A spray apparatus comprising:
an outlet connected to a cyclone chamber;
at least one inlet to the chamber connected to a source of liquid pressurized using volatile organic compounds;
wherein the cyclone chamber has a cross section that decreases in a direction away from the outlet and a closed base such that in use the liquid entering the chamber forms a reverse flow cyclone, and wherein the liquid travels in a first direction away from the inlet to the closed base and thereafter reverses direction and travels towards the outlet.

56. An apparatus as claimed in claim 55, wherein the cyclone chamber is pre-dosed with a substance before use.

57. A method of producing a liquid spray from an outlet connected to a cyclone chamber, wherein the cyclone chamber includes a cross section that decreases in a direction away from the outlet and a closed base, the method comprising:
passing a pressurized gas into the cyclone chamber via at least one gas inlet;
passing a pressurized liquid into the cyclone chamber via at least one liquid inlet and thereby forming a reverse flow cyclone from at least one of the liquid and gas in which the liquid or gas travels in a first direction away from the inlet to the closed base and thereafter reverses direction and travels towards the outlet so as to form droplets of the liquid in the cyclone chamber, the droplets being sprayed out from the outlet.

58. A method as claimed in claim 57, further comprising using the pressurized source of gas to pressurize the liquid.

59. A method as claimed in claim 57, further comprising passing the gas into the cyclone chamber before the liquid.

60. A method as claimed in claim 57, further comprising ceasing passing the gas into the cyclone chamber after ceasing passing the liquid into the chamber.

61. A method of producing a liquid spray from an outlet comprising using an apparatus as claimed in claim 38.

62. A method of producing a liquid spray from an outlet comprising using an apparatus as claimed in claim 55.
